(19) United States
(12) Patent Application Publication
(10) Pub. No.: US 2007/0029378 A1
(43) Pub. Date: Feb. 8, 2007

(54) Change card

(76) Inventor: Jeffrey J. Begola, Philadelphia, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/545,664

(22) Filed: Oct. 10, 2006

Related U.S. Application Data
(63) Continuation-in-part of application No. 10/983,203, filed on Nov. 5, 2004.

(51) Int. Cl. G06K 5/00; G07F 19/00; G06Q 20/00

(52) U.S. Cl. 235/380; 235/379; 705/17

(57) ABSTRACT

A transaction card allows for retail purchases involving fractional dollar amounts to be completed without the use of coin currency. Change amounts involving less than one dollar can be either credited to or debited from a monetary value stored on a smart chip in the transaction card by placing the transaction card into a card reader that reads a magnetic swipe strip associated with the smart chip. Amounts credited to the transaction card can be used for secondary transactions not involving paper or coin currency.

### RELATED APPLICATIONS

This application is a continuation-in-part of patent application Ser. No. 10/983,203 filed on Nov. 5, 2004.

### FIELD OF THE INVENTION

The present invention relates generally to the field of transaction cards, such as debit cards, wherein a monetary value is stored in a computer readable format, such as a magnetic swipe strip. More specifically, the present invention relates to a system and method for using a transaction card to replace the use of coinage in a variety of retail and other transactions.

### BACKGROUND OF THE INVENTION

Many transactions engaged in by individuals on a daily basis involve using coin currency. Very rarely does a retail transaction involve a whole dollar amount, with no change in coins being exchanged. As a result, individuals are constantly either giving or receiving change in the form of heavy, bulky coins. Not only are coins heavy and bulky to carry, they are easily lost.

As a result, many individuals opt not to carry coins of any type; instead depositing the days accumulated change into ajar or bowl. This practice leads to the loss of significant value to an individual, since the value of change accumulated over the course of a week can easily amount to several dollars, and may be well over one hundred dollars over the course of a year.

One method to recapture this value is by rolling spare change and making a deposit at a local bank, or going to a coin counting machine. However, rolling change is time consuming, inaccurate and requires a minimum value of coins before it becomes worthwhile. Further, the use of coin counting machines usually involves a fee. In addition, the value of the coins is lost to the individual while waiting to obtain the critical mass necessary to make rolling the change orgoing to a coin machine worthwhile.

It would therefore be desirable to provide a system and method for eliminating the use of coin change in retail and other transactions. Such a system and method would be convenient and make the value of change readily available to be exploited.

### SUMMARY OF THE INVENTION

The present invention provides a system and method for using a transaction card to replace the use of coinage in a variety of retail and other transactions wherein the purchase price of an item includes a fractional dollar amount. The present invention therefore provides a system and method for completing a transaction without the use of coins.

The method according to the current invention comprises providing a transaction card, which has a card body with a memory storage disposed on the card body. The memory storage is generally a smart chip, either incorporated into a magnetic swipe strip capable of being read by a card reader, or a contact-less method for reading the information stored on the card, such as radio frequency (RF). It is also contemplated that the transaction card according to the present invention may have both a magnetic swipe strip and contact-less system, which may be used alternatively. The memory storage is used for storing an identification, generally and alpha-numeric code, for an account associated with the transaction card and a monetary value associated with the account, and therefore with the transaction card.

According to the method, when purchasing goods or services having a purchase price including a fractional dollar amount, a whole dollar amount in currency either above or below said purchase price is tendered, along with the transaction card. The difference between the purchase price and the whole dollar amount tendered is of course represented at least in part by a value in coins less than one dollar.

The value in coins less than one dollar is credited or debited from the transaction card account via a card reader at the point of sale. In alternative embodiments, this may include inserting the transaction card into a first card reader, or in the case of a contact-less system, simply passing the card in close proximity to the card reader. The first card reader reads the transaction card identification and the monetary value associated with the account associated with the card. An updated monetary value is created and associated with the transaction card and account by either crediting an overpayment credit to the monetary value, or debiting an underpayment debit from the monetary value via the card reader. The credit or debit will be at least the value in coins less than one dollar, but may be the entire difference between the purchase price and the whole dollar amount tendered.

In addition, the identification for the transaction card and the updated monetary value are stored in a memory storage in the first card reader. The data from one or more such transactions may then be transmitted, including the transaction card identification and updated monetary value from the memory storage in the first card reader to a central database. The data may then be erased from the memory storage in the first card reader. The central database may comprise a plurality of accounts, each of the accounts having an associated transaction card identification, and each reflecting a monetary value for the associated transaction card identification. The plurality of accounts may be updated periodically by receiving transmissions from at least one card reader having at least one transaction card identification and monetary value recorded therein. Further, the merchant would be re-imbursed by the financial institution for the monetary value. In an alternative embodiment, the first card reader includes a removable memory, such as a floppy disk, flash memory, tape or writable optical disk. In this embodiment the removable storage would provide a way for the merchant to transfer the data collected and stored on the change card reader to a financial institution as a way of transmitting the change card data collected, should a direct data line not be accessible to upload the information to the financial institution directly. Or in the case where a data line is accessible, it would serve as a back-up of accounting information for the merchant similar to how a receipt of sales is used when paying in cash or credit card. In one example of this removable storage device the merchant could simply open the change card reader and remove the removable storage device and mail it off to the financial institution. The financial institution would then read the data from the removable storage device and re-imburse the merchant for the money collected.

In a preferred embodiment, the monetary value stored on the transaction card memory is available for secondary transactions that do not include the use of paper currency or coins. In such secondary transactions a total item purchase price is paid by passing the transaction card into or through a second card reader or contact-less system, thereby debiting the total item purchase price from the monetary value stored on the transaction card memory to generate an updated monetary value. Such transactions may be recorded in a memory storage in the second card reader. Such secondary transactions may be selected from the non-limiting examples of vending machines, parking meters, telephone services, public transportation fares, gaming/gambling machines, arcade games, juke boxes, pool tables, car washes/vacuums, toll booths, news paper boxes, copiers, laundromats, amusement rides, cyber cafes, cigarette machines, over-the-counter retail transactions and automatic teller machine (ATM) deposits.

### BRIEF DESCRIPTION OF THE DRAWINGS

FIG. 1 Illustrates a frontal view of a transaction card according to the current invention.

FIG. 2 Illustrates a rear view of a transaction card according to the current invention.

FIG. 3 Illustrates an alternative embodiment of a transaction card according to the current invention.

FIG. 4 Illustrates a card reader useful with the method according to the current invention.

FIG. 5 Illustrates a scan box gun useful with the method according to the current invention.

### DETAILED DESCRIPTION

The present invention provides a system and method for eliminating the need to use coinage in retail and other transactions.

The method uses a transaction card that is similar to traditional debit and credit cards. In general, the transaction card comprises a card body of plastic or other suitable material, with a memory storage disposed on the card body. In one embodiment the memory storage comprises a smart chip embedded in a magnetic swipe strip for reading and writing data to the card. In an alternative embodiment, the swipe strip is either replaced by or complimented with a contact-less system, such as radio frequency (RF). A transaction card identification and a monetary value are stored on the memory storage. The transaction card identification is associated with an account at a bank or other financial or commercial institution, which is the issuer of the card. Unlike a debit card, the transaction card is typically, although not necessarily issued with a zero balance.

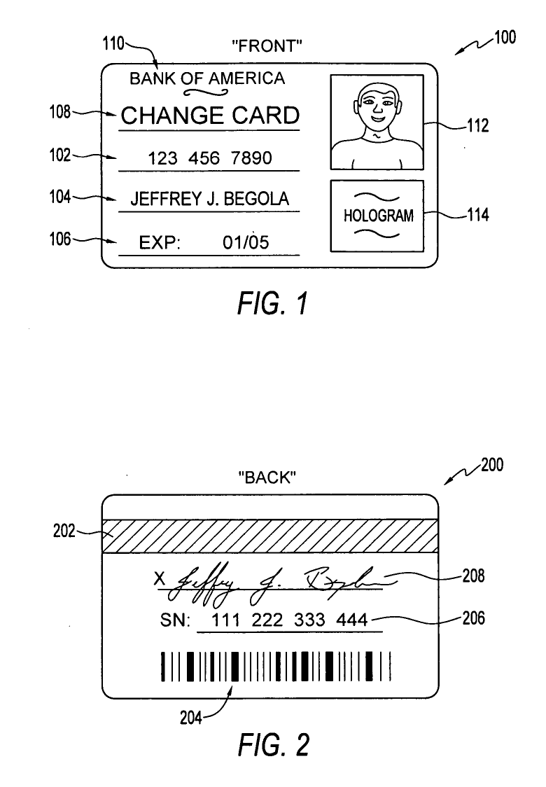

Referring to FIGS. 1 and 2, an exemplary transaction card according to an embodiment of the current invention is shown. FIG. 1 shows the front of an exemplary transaction card 100 according to the current invention. The front of the transaction card 100 may contain information about the transaction card, such as an alpha-numeric identification 102, the name of the cardholder 104, and an expiration date 106. In addition, the front of the transaction card 100 may contain information such as a title of the transaction card 108 and the name of the issuing institution 110. The front of the transaction card may also have security features such as a photograph of the cardholder 112 and a security hologram 114.

Referring to FIG. 2, the back of an exemplary transaction card 200 according to the current invention is illustrated. The back of the transaction card 200 preferably has the magnetic swipe strip 202 disposed thereon. A smart chip, not visible, is embedded in the magnetic swipe strip. It will be understood that where a contact-less system is used in conjunction with the present invention, the swipe strip may be absent. In addition to the magnetic swipe strip 202 the back of the transaction card 200 may also have a UPC bar code 204 which contains the transaction card identification and can be related to the monetary value associated with the card. The UPC bar code can be used by the card issuer to recall the card identification and monetary value should the magnetic swipe strip become corrupt. The back of the transaction card 200 may also have an alpha-numeric production serial number 206 as a security feature and space for the card holder's signature 208 as an additional security feature.

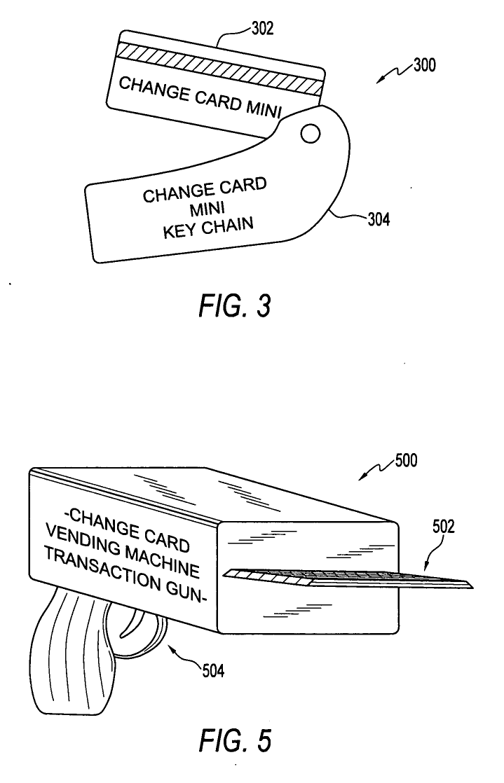

Referring to FIG. 3 an alternative embodiment of the transaction card 300 is shown. In this alternative embodiment, the transaction card body 302 is incorporated into a protective plastic sleeve 304. In this embodiment the transaction card can be attached to a cardholders key chain or other personal item.

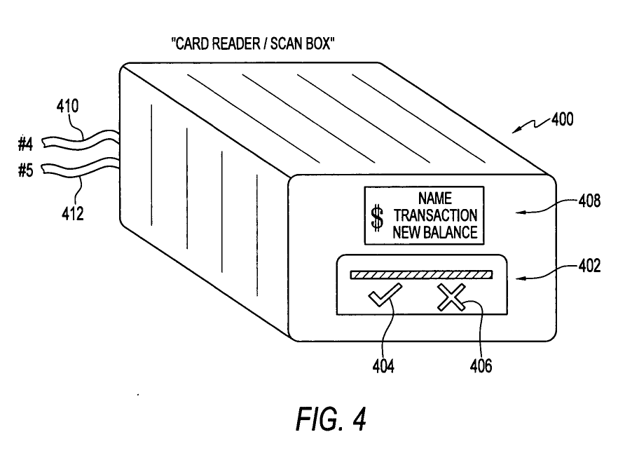

Referring to FIG. 4, an exemplary card reader 400 useful with the current inventive method is illustrated. To perform a transaction the transaction card is inserted into slot 402. The card reader 400 is optionally equipped with indicators 404 and 406. In the exemplary embodiment shown in FIG. 4 the check mark (√) indicator 404 indicates a successful card read. The (X) mark indicator 406 indicates an unsuccessful card read. The card reader 400 may also be equipped with an LED display 408. When the transaction card is inserted into the slot 402 the LED display may display such information as the cardholders name, the monetary value of the card before a transaction, the value of the transaction, and a new updated monetary value after the transaction is completed. The card reader 400 may also have a hard wire connection 410, such as a telephone line to communicate with a central database, and a hard wire connection 412 to a power source. It will be recognized that internal power sources and wireless connections are also within the scope of the present invention. According to an alternative embodiment, the card reader will make use of a contact-less system, which would not require the transaction card to be inserted into the card reader.

By way of example, in the embodiment illustrated in FIG. 4, the internal configuration of the card reader will comprise a magnetic strip reader/writer for updating the transaction card's memory, a card insertion and ejection mechanism, and a computer hard drive or other internal memory device for storing a record of all of the monetary values and card identifications from the day's transactions. The internal memory also stores the updated monetary value for each transaction card for which a transaction was processed on a given day. At regular intervals, such as at the end of each business day all of the data stored on the internal memory of the card reader is transmitted via telephone lines or other means to a central database. The internal memory may either be fixed in the reader, or may be removable. Exemplary embodiments of a removable memory include floppy disk, flash memory, writable optical disk and magnetic tape.

The central database is maintained by the card issuer or an affiliate and contains a record of the alpha-numeric identification and associated monetary value for each card that it has issued. In addition, the database may contain information such as the name, address and telephone number of the cardholder, among other personal identifying information. The monetary value associated with the transaction card is updated on a periodic basis as data transmissions are received from the card readers at the various locations where transactions are completed. In a preferred embodiment, transmissions of data are made by the card readers and received by the central database on a daily basis, such as at the end of each business day. In another preferred embodiment, after a card reader has transmitted its stored data to the central database, the card reader internal memory is automatically erased to prepare for the next cycle of transactions.

This mode of operation, whereby transactions are stored rather than communicated to the central database on an individual basis speeds the transaction process since time is not spent contacting and communicating transaction information to and from the central database each time an individual transaction is completed. This produces a quicker transaction and also eliminates the difficulties that occur when communication with the central database cannot be established.

In standard retail settings the card reader can be placed adjacent to a cash register to permit convenient tendering of the transaction card by a cardholder. In an alternative embodiment the card reader may be placed in connection with or internal to a vending machine or other coin fed device. In this embodiment the entire transaction is completed without the use of paper or coin currency. The cardholder simply inserts the transaction card into the slot of the card reader or passes the card in proximity to a contact-less communication device in the card reader, and the entire purchase value of the goods or services purchased is deducted from the monetary value of the transaction card. Non-limiting examples of secondary transactions that can be completed in this way are, vending machines, parking meters, telephone services, public transportation fares, gaming/gambling machines, arcade games, juke boxes, pool tables, car washes/vacuums, toll booths, news paper boxes, copiers, laundromats, amusement rides, cyber cafes, cigarette machines, and over-the-counter retail transactions. In addition to retail purchases at coin fed machines, the transaction card can also be used to make bank account deposits, either over the counter or via ATMs.

In the case of coin fed vending machines and other transactions at coin fed machines the card reader may not be directly in communication with the central database. Rather, data for transactions will be stored in the internal card reader memory and will be manually emptied periodically by an attendant. In this embodiment, a device for downloading information from the internal card reader memory may be inserted into the card reader slot and the transaction data will be downloaded to the device. Referring to FIG. 5, in one embodiment the device comprises a scan box gun 500. A tongue element 502 on the scan box gun 500 is inserted into the card reader slot. By simply pulling the trigger 504 the data stored in the card reader internal memory will be able to be downloaded to an internal hard drive in the scan box gun 500. In an alternative embodiment, the card reader in such coin fed vending machines may include a removable memory, such as those discussed above.

As stated previously, the monetary value associated with the transaction card will be stored in the card's memory storage. In a preferred embodiment, the monetary value will be stored and expressed in 1 cent increments without the use of decimals, wherein 1 bit of information is equal to 1 cent. For example, a stored value of 000025 bits would be equal to 25 cents or $0.25. A stored value of 000235 bits would be equal to 235 cents or $2.35.

The method according to the current invention will now be further explained by way of non-limiting example. A new transaction card having an identification code 123456 is issued to an individual cardholder. Initially the transaction card has a monetary value of $0.00, which is recorded in the card memory as 000000. In addition, an account is set up in a central database, which is administered by the financial or commercial institution that issued the card. The account in the central database contains the transaction card identification 123456, as well as the initial monetary value of 000000. The account may, and preferably does contain additional personal information about the cardholder.

When the cardholder makes a purchase that includes a fractional dollar amount, such as purchasing a pack of gum for $0.25, the cardholder tenders $1.00 cash in payment and the transaction card. In lieu of receiving $0.75 in coins as change, the merchant inserts the transaction card into the card reader and credits $0.75 to the transaction card. The card now has a stored monetary value of 000075. In addition to crediting $0.75 to the transaction card, the card reader stores the card identification, the initial 000000 monetary value and the 000075 updated monetary value on its internal memory.

If the cardholder makes a second purchase, say $1.15 for a cup of coffee, the cardholder tenders $2.00 cash in payment, along with the transaction card. The $0.85 in change is credited to the card in lieu of coins, giving the transaction card a new updated monetary value of 000160, or $1.60. Again, the card reader stores the card identification, the initial 000075 monetary value and the 000160 updated monetary value.

A third transaction may involve purchasing a tube of toothpaste, for $2.25. In this case, the cardholder may choose to tender $2.00 in cash, along with the transaction card. In this case, 000025, or $0.25 would be debited from the stored monetary value, giving a new updated monetary value of 000135. Again, the card reader stores the card identification, the initial 000160 monetary value and the 000135 updated monetary value.

At the end of the business day, all three of these transactions are forwarded to the central database and the account for the transaction card is updated to reflect the three transactions.

In one embodiment, where the difference between an item purchase value and the amount tendered includes both fractional and whole dollar amounts, the entire difference may be either credited to or debited from the monetary value stored on the transaction card. For example, if an individual purchases an item with a purchase value of $8.50, the individual may tender $10.00 along with the transaction card. In this case the entire $1.50 in change could be credited to the transaction card.

The monetary value stored in the transaction card memory is also available for secondary transactions, wherein the entire purchase price is debited from the monetary value of the transaction card. Alternatively, all or a portion of the monetary value can be deposited to a bank account via an ATM or over the counter transaction.

The invention has thus been described with reference to exemplary drawings and other non-limiting examples. It will be apparent to those of ordinary skill in the art that other variations of the invention may be made without departing from the spirit and scope of the invention.

What is claimed is:

1. A method for completing a transaction without the use of coins, the method comprising:
providing a transaction card comprising a card body and a memory storage disposed on said card body, said memory storage comprising a smart chip capable of being read by a card reader, said memory storage storing an identification for said transaction card and a monetary value for said transaction card;
purchasing goods or services having a purchase price including a fractional dollar amount;
tendering a whole dollar amount in currency either above or below said purchase price, wherein the difference between said purchase price and the whole dollar amount tendered is represented at least in part by a value in coins less than one dollar;
reading of said transaction card by a first card reader, said first card reader reading said transaction card identification and said monetary value;
generating an updated monetary value in said memory storage via said card reader; and
recording said identification for said transaction card and said updated monetary value in a memory storage in said first card reader;
wherein said monetary value is capable of both being increased by crediting an overpayment amount to said transaction card and being decreased by debiting an underpayment amount to said transaction card.

2. The method according to claim 1, further comprising:
transmitting said transaction card identification and said updated monetary value from said memory storage in said first card reader to a central database; and
erasing said transaction card identification and said updated monetary value from said memory storage in said first card reader.

3. The method according to claim 2, wherein:
said transmitting and erasing occurs on a once daily basis.

4. The method according to claim 2, wherein,
said central database comprises a plurality of accounts, each of said accounts having an associated transaction card identification, each of said plurality of accounts reflecting a monetary value for said associated transaction card identification,
said plurality of accounts being updated periodically by receiving transmissions from at least one card reader having at least one transaction card identification and monetary value recorded therein.

5. The method according to claim 1, wherein the memory storage in said first card reader is removable.

6. The method according to claim 1, wherein:
said transaction card is provided with a zero initial monetary value.

7. The method according to claim 1, wherein:
said monetary value is available for a secondary transaction wherein a total item purchase price is paid by passing said transaction card through a second card reader, thereby debiting said total item purchase price from said monetary value to generate an updated monetary value.

8. The method according to claim 7, wherein:
said updated monetary value and said transaction card identification are recorded by said second card reader in a memory storage.

9. The method according to claim 8, further comprising:
retrieving said updated monetary value and said transaction card identification recorded by said second card reader by inserting a retrieval device into said second card reader.

10. The method according to claim 9, further comprising:
erasing said updated monetary value and said transaction card identification from said second card reader after said retrieving.

11. The method according to claim 9, wherein said retrieval device comprises a scan box gun, and said updated monetary value and transaction card identification are upload from said scan box gun to said central database.

12. The method according to claim 8, wherein the memory storage in the second card reader is removable.

13. The method according to claim 1, wherein
said monetary value is stored on said memory storage as a plurality of bits of information, wherein one bit of information corresponds to a monetary value of $0.01.

14. The method according to claim 1, wherein:
said transaction card further comprises at least one feature selected from the group consisting of: a UPC scan strip, a photo of a transaction card holder, a hologram security feature, a financial institution name, a transaction card title, said transaction card identification, the name of a transaction card holder, an expiration date, a card holder signature, and a transaction card production serial number.

15. A transaction card comprising:
a card body and a memory storage disposed on said card body, said memory storage comprising a smart chip capable of being read by a card reader, said memory storage storing an identification for said transaction card and a monetary value for said transaction card;
said monetary value being capable of being either increased or decreased as part of a point of sale transaction, wherein a purchase is made by tendering a whole dollar monetary value either above or below a purchase price, wherein the difference between said purchase price and the whole dollar amount tendered is represented at least in part by a value in coins less than one dollar.

16. The transaction card according to claim 15, wherein said card includes a magnetic swipe strip capable of being read by said card reader.

17. The transaction card according to claim 15, wherein said card includes radio frequency communication capable of being read by said card reader.
